(19) United States
(12) Patent Application Publication
(10) Pub. No.: US 2012/0307152 A1
(43) Pub. Date: Dec. 6, 2012

(54) VIDEO ADVERTISEMENT PROGRESS TIME INDICATOR

(75) Inventors: Eduard Zaslavsky, Issaquah, WA (US); Arthur Vaysman, San Jose, CA (US)

(73) Assignee: WebTuner, Corporation, Redmond, WA (US)

(21) Appl. No.: 13/487,528

(22) Filed: Jun. 4, 2012

Related U.S. Application Data
(60) Provisional application No. 61/492,431, filed on Jun. 2, 2011.

(51) Int. Cl. H04N 5/445

(52) U.S. Cl. 348/564; 348/E05.099

(57) ABSTRACT

A method of indicating to a viewer the time remaining in a video advertisement, a system implementing the method, and a TV commercial are disclosed. The method comprises, on a processor, displaying a video advertisement, superimposing an indicator on the video advertisement, wherein the indicator bar has a first portion indicating the time remaining in the video advertisement and a second portion indicating the time that has elapsed in the video advertisement, and decreasing the size of the first portion and increasing the size of the second portion until the video advertisement is completed.

### REFERENCE TO RELATED APPLICATIONS

This application claims priority to U.S. provisional Application Ser. No. 61/492,431, filed Jun. 2, 2011, entitled “Video Ad Progress Time Indication Method and Apparatus,” which is all hereby specifically and entirely incorporated by reference.

### BACKGROUND

1. Field of the Invention

The invention is directed to television advertisements. Specifically, the invention is directed to interactive or transaction enabled video advertisements.

2. Background of the Invention

In existing television (TV) systems, advertisements (ads or commercials), including audio and/or video and/or interactive enhancements (for example Enhanced TV Binary Interchange Format (EBIF) applications), are injected at several points. Ads can be injected by, for example the national broadcasters (i.e. NBC or ABC), the programming networks (e.g. ESPN), the local programming network affiliates, the cable operators (or equivalent) with centralized ad injection at the head-end, the cable operators with targeted ads with distributed injection over switched digital video infrastructure, cable operators with targeted ads stored in Digital Video Recorders (DVRs) and injected into live or recorded streams, Video on Demand (VOD) operators, or Internet video streaming operators.

Interactive or transaction enabled video ads, especially ones created by adding text banners or symbolic element enhancements to an existing or a newly created video ad, provide no visual clues to viewers as to when the opportunity to interact or transact with the ad expires. Some suggested solutions are to add a digital based countdown timer or a symbol based countdown timer. However, both of these methods occupy precious space on the screen and take the viewer's attention away from the ad.

### SUMMARY OF THE INVENTION

The present invention overcomes the problems and disadvantages associated with current strategies and designs and provides new tools and methods of enhancing interactive or transaction enabled video ads.

One embodiment of the invention is directed to a method of indicating to a viewer the time remaining in a video advertisement. The method comprises displaying a video advertisement, superimposing an indicator on the video advertisement, wherein the indicator bar has a first portion indicating the time remaining in the video advertisement and a second portion indicating the time that has elapsed in the video advertisement, and decreasing the size of the first portion and increasing the size of the second portion until the video advertisement is completed.

Preferably, the video advertisement is an interactive television commercial and the indicator bar indicates the time remaining for a viewer to interact with the commercial. In the preferred embodiment an offer related to the video advertisement is displayed in the indicator. The decrease in size of the first portion and the increase in size of the second portion are preferably proportional to the time remaining in the video advertisement.

In the preferred embodiment, the decrease in size of the first portion and the increase in size of the second portion are at an equal rate. Preferably, at least a percentage of the indicator is translucent. Preferably, the first portion is translucent and the second portion is opaque or the first portion is opaque and the second portion is translucent. Preferably, the first portion and the second portion have different colors, opacities, textures, or combinations thereof. The indicator is preferably a bar. The decrease in size of the first portion and the increase in size of the second portion are preferably continuous.

Another embodiment of the invention is directed to a system for displaying a video advertisement while indicating to a viewer the time remaining in the video advertisement. The system comprises a processor, a display coupled to the processor, and software executing on the processor. The software displays a video advertisement on the display, superimposes an indicator on the video advertisement, wherein the indicator bar has a first portion indicating the time remaining in the video advertisement and a second portion indicating the time that has elapsed in the video advertisement, and decreases the size of the first portion and increases the size of the second portion until the video advertisement is completed.

Preferably, the video advertisement is an interactive television commercial and the indicator indicates the time remaining for a viewer to interact with the commercial. In the preferred embodiment, an offer related to the video advertisement is displayed in the indicator. The decrease in size of the first portion and the increase in size of the second portion are preferably proportional to the time remaining in the video advertisement. The decrease in size of the first portion and the increase in size of the second portion are preferably at an equal rate.

In the preferred embodiment, at least a percentage of the indicator is translucent. Preferably, the first portion is translucent and the second portion is opaque or the first portion is opaque and the second portion is translucent. Preferably, the first portion and the second portion have different colors, opacities, textures, or combinations thereof. The indicator is preferably a bar. The decrease in size of the first portion and the increase in size of the second portion are preferably continuous.

Another embodiment of the invention is directed to a video advertisement having an indication of the time remaining in the video advertisement. The video advertisement comprises an indicator superimposed on the video advertisement, wherein the indicator bar has a first portion indicating the time remaining in the video advertisement and a second portion indicating the time that has elapsed in the video advertisement, and wherein the size of the first portion decreases and the size of the second portion increases until the video advertisement is completed.

Preferably, the video advertisement is an interactive television commercial and the indicator indicates the time remaining for a viewer to interact with the commercial. The video advertisement preferably further comprises an offer related to the video advertisement displayed in the indicator. Preferably the decrease in size of the first portion and the increase in size of the second portion are proportional to the time remaining in the video advertisement. In the preferred embodiment, the decrease in size of the first portion and the increase in size of the second portion are at an equal rate.

Preferably, at least a percentage of the indicator is translucent. In the preferred embodiment, the first portion is translucent and the second portion is opaque or the first portion is opaque and the second portion is translucent. Preferably, the first portion and the second portion have different colors, opacities, textures, or combinations thereof. The indicator is preferably a bar. Preferably, decrease in size of the first portion and the increase in size of the second portion is continuous.

Other embodiments and advantages of the invention are set forth in part in the description, which follows, and in part, may be obvious from this description, or may be learned from the practice of the invention.

### DESCRIPTION OF THE DRAWING

The invention is described in greater detail by way of example only and with reference to the attached drawing, in which:

FIG. 1 depicts an example of a screen shot of video advertisement enhanced by an interactive element.

FIG. 2 depicts three time slices of an interactive ad with a background element.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention

A problem in the art capable of being solved by the embodiments of the present invention is relaying to viewers of interactive or transaction enable video ads the time frame to interact or transact with the ad. The present invention solves the problem of providing a visual clue to a viewer as to when the opportunity to interact or transact with the ad expires by proportionally changing a section a banner's color, opacity (translucency to underlying video), or texture based on and proportionately to the time remaining in the ad's playback or pause.

In a preferred embodiment, interactive or transaction enable video ads comprise the video component of the ad, the audio component of the ad, text or other indicator of the specific interaction or transaction that can be initiated by the viewer during the ad's playback, at least one graphical element (e.g. image or button) that indicates specific interactions or transactions that can be initiated by the viewer during the ad's playback, and a background element on top of which text and/or symbolic graphical elements are displayed.

Since text or symbolic graphical elements appear clearer against contrasting surroundings than against similarly colored surroundings, it is difficult to choose a color for the text or symbolic graphical element that would appear clear against an always changing video. In the preferred embodiment, the advertisement and television industries would adopt usages of background elements as a surrounding for a text or symbolic graphical element displayed during video playback or pause. The background element (which can be, for example, a rectangle or banner) is preferably an element of a specific color, opacity, texture, or combination thereof.

Advertisements that are capable of having interactive or transactional elements are created by advertisers who purchase national ad slots, advertisers who purchase local ad slots or local advertisers who customize or personalize national ads. The metadata and controlling signal related to interactive or transaction enabled ad can be inserted by the national broadcaster, the local broadcaster, or the service operator. The playback of interactive or transaction enabled ad and rendering of background element indicating the amount of time remaining to interact or transact with the ad can be performed by a client device (e.g. set top box or computer).

### Example

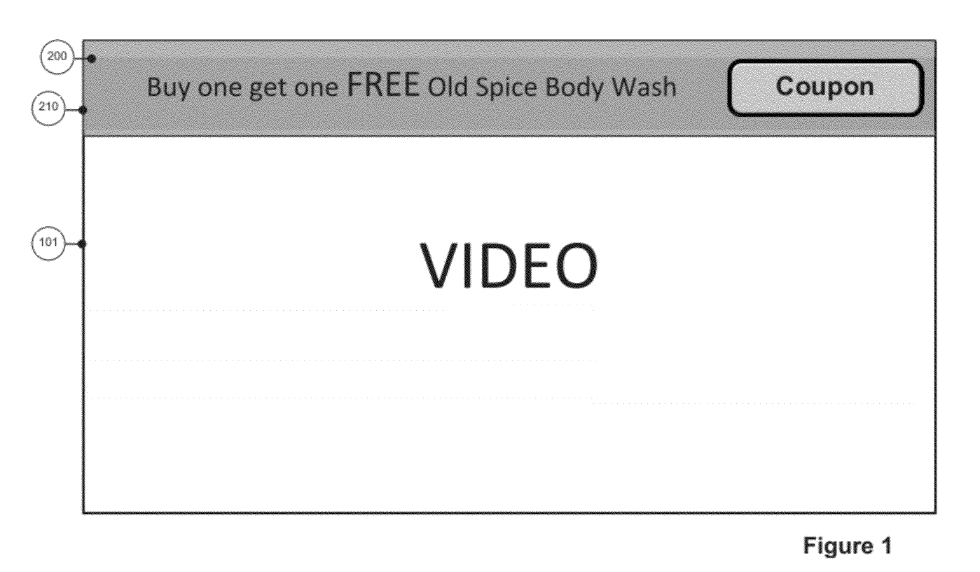

FIG. 1 depicts a preferred embodiment of a video ad 101 enhanced by an interactive element that allows a viewer to order a coupon for a buy one get one free offer. Interactive components including background element 210 consists of pixels with the same visual properties (e.g. color, and opacity). While background element 210 is depicted along the top of the video, background element 210 can be positioned along the bottom of the video, along one side of the video, at another location within the video, and combinations thereof.

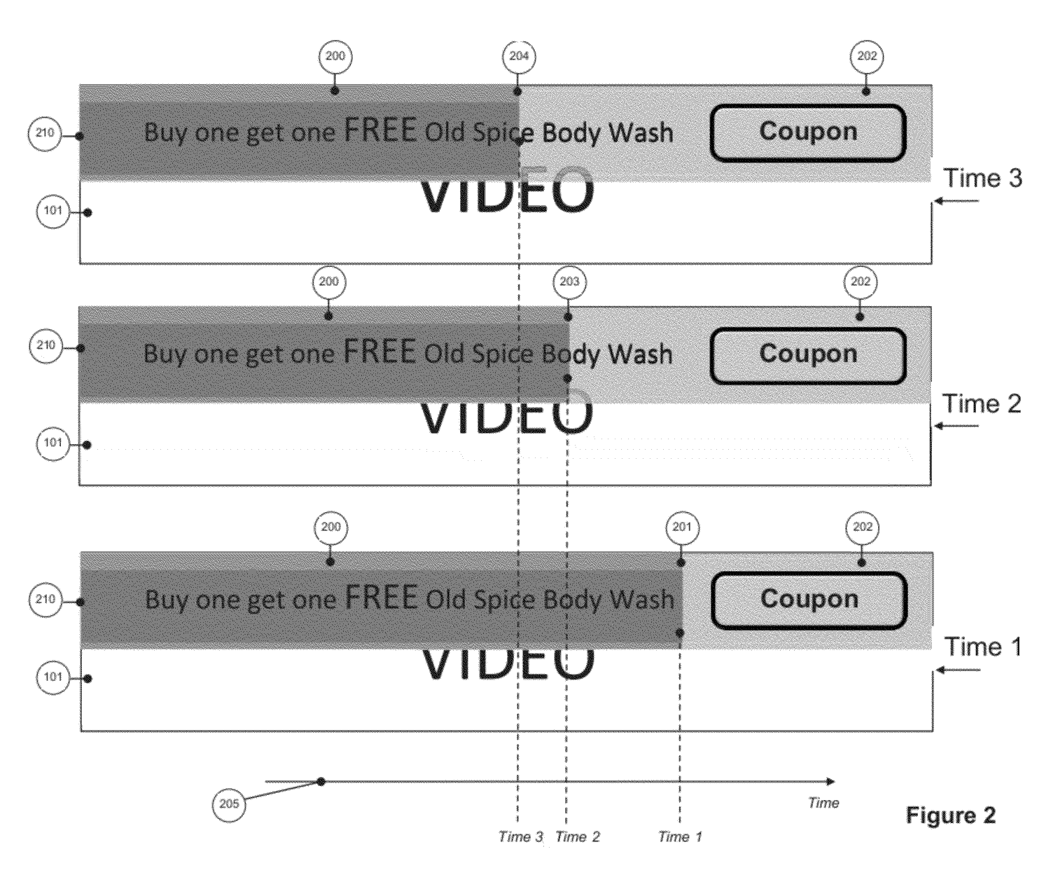

FIG. 2 depicts three time slices (Time1, Time2, and Time3) of an interactive ad with background element 210 changing its opacity inversely proportionate to the time 205 left for a viewer to act on the interactive offer.

Video portion of ad 101 is covered by background element 210, a portion of which 202 changes proportionately in time as an indicator to a viewer of the time left to act on the displayed offer by clicking on a button labeled “Coupon.” As the time decreased from Time3 to Time1, background element 210 increasingly gets more opaque from left to right, changing from position 204 at Time3 to position 203 at Time2, to position 201 at Time1.

In this example, background element 210 has two areas of different opacity, portion 202 and portion 200, which change their widths proportionately with the time left in the commercial. While portion 202 and portion 200 are shown with different opacity, instead the two portions may have the same opacity but different colors or another indication between the differences in the two portions. With time, the width of portion 200 increases whiles the width of portion 202 decreases. Additionally, the border between portion 200 and 202 also moves as the relative widths of the two portions change. While the movement is shown from left to right, the movement can be from right to left, top to bottom, bottom to top, at a diagonal or can have another movement. Furthermore, the background element may be of another shape, such as a circle, a logo, a spiral, a line, an image, a set of images, or an icon. The background element may fade, become opaque, move across the screen, change shape, size, or color, or have another indication of time remaining.

While the examples provided herein are for TV viewing systems, the invention is also applicable to other video and audio applications involving an audience, including, but not limited to, video viewing on PCs, tablets, smart phones, game consoles, and other streaming and linear programming devices.

Although the exemplary environment described herein employs a hard disk database, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Networks may include the Internet, one or more Local Area Networks (“LANs”), one or more Metropolitan Area Networks (“MANs”), one or more Wide Area Networks (“WANs”), one or more Intranets, etc. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A method of indicating to a viewer the time remaining in a video advertisement, comprising:
displaying a video advertisement;
superimposing an indicator on the video advertisement, wherein the indicator has a first portion indicating the time remaining in the video advertisement and a second portion indicating the time that has elapsed in the video advertisement; and
decreasing the size of the first portion and increasing the size of the second portion until the video advertisement is completed.

2. The method of claim 1, wherein the video advertisement is an interactive television commercial and the indicator indicates the time remaining for a viewer to interact with the commercial.

3. The method of claim 2, wherein an offer related to the video advertisement is displayed in the indicator.

4. The method of claim 1, wherein the decrease in size of the first portion and the increase in size of the second portion is proportional to the time remaining in the video advertisement.

5. The method of claim 4, wherein the decrease in size of the first portion and the increase in size of the second portion are at an equal rate.

6. The method of claim 1, wherein at least a percentage of the indicator is translucent.

7. The method of claim 6, wherein the first portion is translucent and the second portion is opaque or the first portion is opaque and the second portion is translucent.

8. The method of claim 1, wherein the first portion and the second portion have different colors, opacities, textures, or combinations thereof.

9. The method of claim 1, wherein the indicator is a bar.

10. The method of claim 1, wherein the decrease in size of the first portion and the increase in size of the second portion are continuous.

11. A system for displaying a video advertisement while indicating to a viewer the time remaining in the video advertisement, comprising:
a processor;
a display coupled to the processor; and
software executing on the processor, wherein the software:
displays a video advertisement on the display;
superimposes an indicator on the video advertisement, wherein the indicator has a first portion indicating the time remaining in the video advertisement and a second portion indicating the time that has elapsed in the video advertisement; and
decreases the size of the first portion and increases the size of the second portion until the video advertisement is completed.

12. The system of claim 11, wherein the video advertisement is an interactive television commercial and the indicator indicates the time remaining for a viewer to interact with the commercial.

13. The system of claim 12, wherein an offer related to the video advertisement is displayed in the indicator.

14. The system of claim 11, wherein the decrease in size of the first portion and the increase in size of the second portion is proportional to the time remaining in the video advertisement.

15. The system of claim 14, wherein the decrease in size of the first portion and the increase in size of the second portion are at an equal rate.

16. The system of claim 11, wherein at least a percentage of the indicator is translucent.

17. The system of claim 16, wherein the first portion is translucent and the second portion is opaque or the first portion is opaque and the second portion is translucent.

18. The system of claim 11, wherein the first portion and the second portion have different colors, opacities, textures, or combinations thereof.

19. The system of claim 11, wherein the indicator is a bar.

20. The system of claim 11, wherein the decrease in size of the first portion and the increase in size of the second portion are continuous.

21. A video advertisement having an indication of the time remaining in the video advertisement, comprising:
indicator superimposed on the video advertisement;
wherein the indicator has a first portion indicating the time remaining in the video advertisement and a second portion indicating the time that has elapsed in the video advertisement; and
wherein the size of the first portion decreases and the size of the second portion increases until the video advertisement is completed.

22. The video advertisement of claim 21, wherein the video advertisement is an interactive television commercial and the indicator indicates the time remaining for a viewer to interact with the commercial.

23. The video advertisement of claim 22, further comprising an offer related to the video advertisement displayed in the indicator.

24. The video advertisement of claim 21, wherein the decrease in size of the first portion and the increase in size of the second portion is proportional to the time remaining in the video advertisement.

25. The video advertisement of claim 24, wherein the decrease in size of the first portion and the increase in size of the second portion are at an equal rate.

26. The video advertisement of claim 21, wherein at least a percentage of the indicator is translucent.

27. The video advertisement of claim 26, wherein the first portion is translucent and the second portion is opaque or the first portion is opaque and the second portion is translucent.

28. The video advertisement of claim 21, wherein the first portion and the second portion have different colors, opacities, textures, or combinations thereof.

29. The video advertisement of claim 21, wherein the indicator is a bar.

30. The video advertisement of claim 21, wherein the decrease in size of the first portion and the increase in size of the second portion are continuous.
